(19) United States
(12) Patent Application Publication
(10) Pub. No.: US 2025/0262111 A1
(43) Pub. Date: Aug. 21, 2025

(54) Back Vertebral Mobilizer

(71) Applicant: Emily Andrews, Ellensburg, WA (US)

(72) Inventor: Emily Andrews, Ellensburg, WA (US)

(21) Appl. No.: 18/582,359

(22) Filed: Feb. 20, 2024

(51) Int. Cl. A61H 1/00

(52) U.S. Cl. CPC A61H 1/008; A61H 2201/1253; A61H 2201/1623; A61H 2201/1695; A61H 2203/0456; A61H 2205/081

(57) ABSTRACT

A back vertebral mobilizer that mobilizes a hypo-mobile vertebra associated with back pain and thoracic kyphosis. The mobilizer includes a main body with a curved lower surface and two upward-extending curved arms. The curved arms are configured so that the distal end of each arm presses against the two transverse processes on an individual's hypo-mobile vertebra when in a supine position over the mobilizer. During treatment, the individual places the curved lower surface of the main body on a flat surface with the two arms extending upward. The individual lays a supine position over the main body so that the distal ends of the two curved arms are aligned directly under the two transverse processes of a hypo-mobilized vertebra. The individual then gently rocks back and forth over the flat surface, which causes the distal ends of the two curved arms to repeatedly apply upward forces to the transverse processes, facilitating movement of the vertebra.

Notice is hereby given that the following patent document contains original material subject to copyright protection. The copyright owner has no objection to the facsimile or digital download reproduction of all or part of the patent document but otherwise reserves all copyrights.

### FIELD AND BACKGROUND OF THE INVENTION

### Field of the Invention

This invention pertains to devices used to treat back pain caused by stiff or hypo-mobile vertebrae and, more particularly, to such devices that an individual may use to restore normal movement of one or more vertebrae.

### Background of the Invention

The described method for addressing back pain through manual vertebral mobilization by a back specialist has proven effective in alleviating discomfort associated with stiff or hypo-mobile vertebrae. However, the reliance of professional assistance limits its accessibility and convenience for individuals seeking relief from the comfort of their homes.

In the realm of spinal health, the described technique extends its applications beyond addressing back pain to encompass the treatment of thoracic kyphosis, a condition marked by an exaggerated forward curvature of the upper thoracic spine commonly linked to aging. Early intervention using spinal mobilization, either independently or in combination with postural corrective training, holds promise in mitigating the progression of thoracic kyphosis and its associated complications, including issues with the neck, shoulder, breathing, and neurological function.

Recognizing the potential benefits of vertebral mobilization, there arises a need for an accessible and user-friendly solution that empowers individuals to perform the procedure at home without relying on external assistance. This envisioned home-based vertebral mobilization would offer a safe and convenient alternative, allowing users to address specific hypo-mobile vertebrae or even target thoracic kyphosis independently. Such innovation holds the potential to democratize spinal care, enabling a broader demographic to take proactive steps in maintaining their back health and preventing the onset or progression of related conditions.

In pursuing this objective, developing user-friendly devices or techniques that mimic the principles of professional vertebral mobilization becomes paramount. These innovations should prioritize safety, ease of use, and effectiveness, empowering individuals to integrate spinal health practices into daily routines. Ultimately, a home-based vertebral mobilization solution could revolutionize the landscape of back care, providing a self-directed approach to addressing common spinal issues and promoting overall well-being.

### SUMMARY OF THE INVENTION

A back vertebral mobilizer intended to be used by individuals at home to mobilize hypo-mobile back vertebrae that can cause back pain and thoracic kyphosis.

The mobilizer includes a rigid body with a curved lower surface and two curved, upward-extending arms, each sharing identical length, spacing, and curvature. The arms extend upward and are strategically positioned to align their distal ends with the vertebra's transverse processes. A central open space is formed between the two arms.

When a user places the main body on a flat surface and assumes a supine position, the mobilizer's arms press against and engage with the transverse processes of a hypo-mobilized vertebrae. Subsequently, as the user gently rocks longitudinally back and forth on the flat surface, the arms exert repetitive upward forces on the transverse processes, inducing the movement of the vertebrae. This mechanism is intended to mimic the effects of professional vertebral mobilization, offering a self-treatment option for individuals seeking to address hypo-mobile vertebrae in the comfort of their homes.

An additional feature of the mobilizer includes optional round tips on each arm's distal end. These tips apply localized or focused pressures on the transverse processes, potentially enhancing the precision and effectiveness of the mobilization process.

The mobilizer's innovative approach aims to democratize spinal care by providing users with a tool for self-directed treatment. Nevertheless, users must exercise caution and mindfulness in its application, recognizing that improper use of excessive pressure could lead to unintended consequences, including increased discomfort.

### BRIEF DESCRIPTION OF DRAWINGS

FIG. 1 is a top plan view of a human lumbar vertebra.

FIG. 2 is a side elevational view of the lumbar vertebra shown in FIG. 1.

FIG. 3 is a side perspective of the back vertebral mobilizer.

FIG. 4 is a top plan view of the back vertebral mobilizer.

FIG. 5 is a side elevational view of the back vertebral mobilizer undergoing up-and-down rocking movement on a flat surface.

FIG. 6 is a rear elevational view of the back vertebrae mobilizer.

FIG. 7 is a front elevational view of the back vertebrae mobilizer.

### DETAILED DESCRIPTION OF THE INVENTION

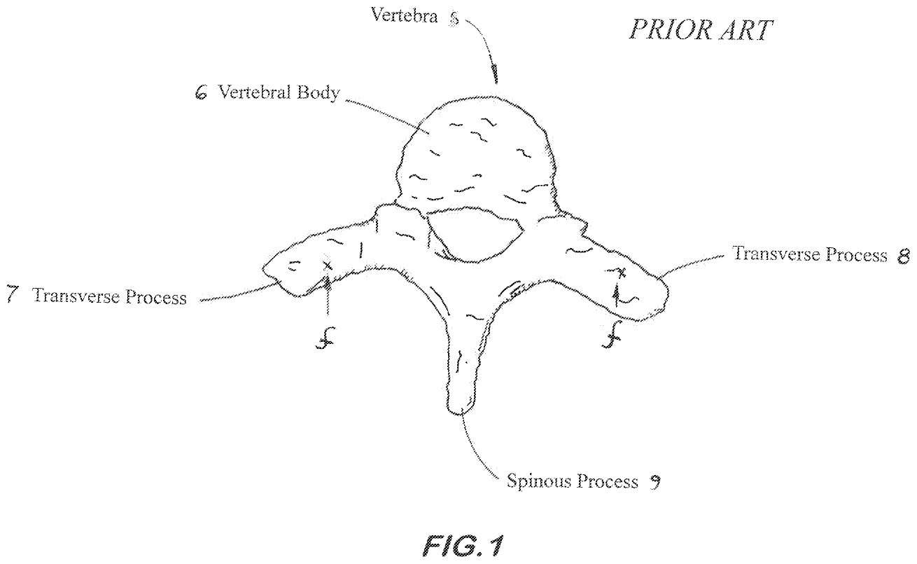

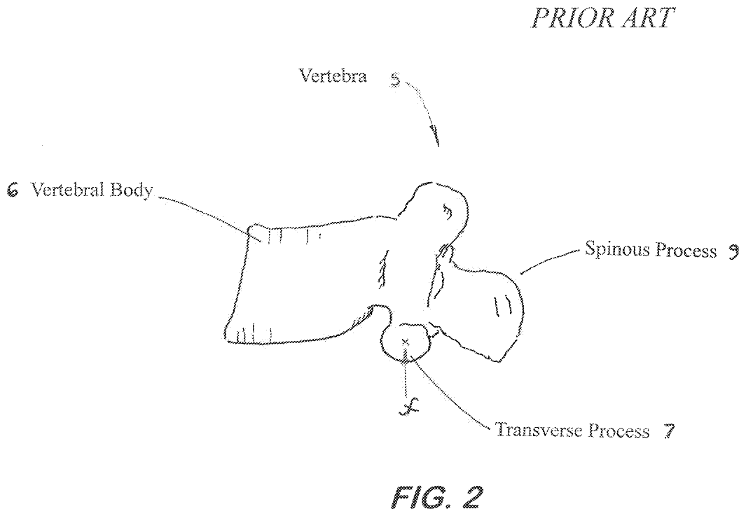

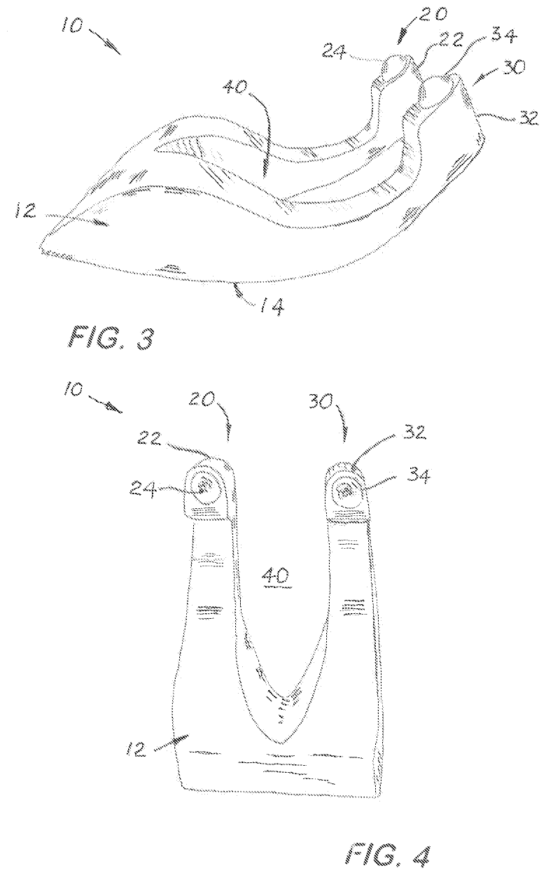

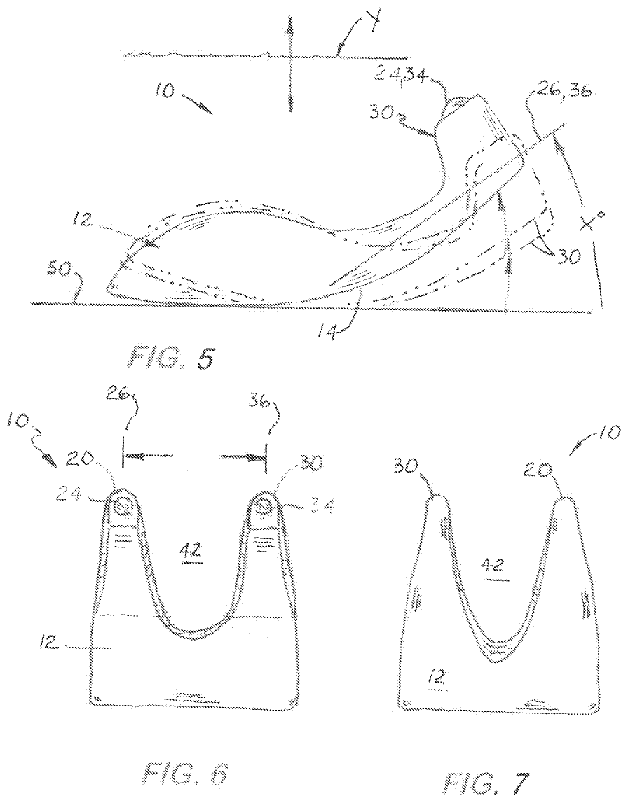

Shown in FIGS. 3-7, there is shown a back vertebral mobilizer 10 intended to be used by individuals at home to mobilize hypo-mobile back vertebrae, which can cause back pain and thoracic kyphosis. A top plan view and side elevational view of a typical lumbar vertebra are shown in FIGS. 1 and 2.

The mobilizer 10 includes a main body 12 made of rigid material with a curved lower surface 14 and two curved, upward-extending arms 20, 30. The curved lower surface 14 is configured to promote an up-and-down rocking motion, as shown in FIG. 5 when the curved lower surface 14 is placed on a flat support surface 50 and the user presses their spine downward into the mobilizer 10.

The lengths and curvatures of the two arms 20, 30 are identical and configured so that the distal ends 22, 32 of each arm 20, 30, respectively, make contact with the vertebra's transverse processes 7, 8 shown in FIGS. 1 and 2 when the user lays supine over the mobilizer 10. A v-shaped central void area 42 is formed between the two arms 20, 30, accommodating the vertebrae's spinous process 9. When a user places the main body 12 on a support surface 50 and lays in a supine position over the main body 12, the distal ends 22, 32, of the two arms 20, 30, respectively, are aligned directly under the transverse processes 7, 9 of a hypo-mobilized vertebrae 5. Ideally, the distal ends 22, 32 should be positioned centrally over each traverse process 7, 8 (see f arrow and ‘x’ in FIGS. 1 and 2). When the user repeatedly lifts and lowers their back, (denoted by reference letter ‘Y’) the main body 12 rocks up and down over the main body 12. The two arms 20, 30 repeatedly apply upward forces (f) to the transverse processes 7, 8 causing the vertebrae 5 to repeatedly move in anterior and posterior directions.

As shown in FIG. 1, the curved arms 20, 30 are angled upward at approximately 30- to 50 degrees (45 degrees preferred), indicated as ‘X’ in FIG. 5. The curvature of the arms 20, 30 enables the user to repetitively lift and lower his spine over the main body 10. During use, the curved arms 20, 30 rock up and down (like a rocking chair) over the flat support surface 50. The angle of the curved arms 20, 30 and their movement are intended to replicate a clinician's hand positioning and the application of adequate forces needed to move the vertebra. If the arm angle is deeper or shallower, then excessive or insufficient force, respectively, would be applied.

As shown in FIG. 4, each arm 20, 30 also gradually narrows towards their distal ends 22, 32 so that a narrow, focused force is only applied to the transverse processes 7, 8 where spinal mobilization in the anterior-posterior directions is meant to apply.

Formed on the distal end 22 and 32 of each arm 20 and 30 is an optional round tip 24 and 34, respectively, that apply localized or focused pressures on the transverse processes 7 and 8.

The main body 12 is approximately 3 inches in width and approximately 4.5 inches in length. The two arms, 20 and 30, are approximately 3.5 inches in length. The distal ends 22, 32 of the arms 20, 30, respectively, are approximately 2.24 apart. The round tips 24, 34 are half-spherical structures the extend above the distal ends 22, 32 approximately ½ inch. When placed on a flat support surface 50 and in a rested, an non-used position, the distal ends 22, 32 are elevated approximately 2 inches above the flat support surface 50.

Also disclosed is a method for an individual to self-treat hypo-mobilized vertebra using the mobilizer, comprising the following steps:
a. identifying a hypo-mobile vertebrae;
b. selecting a flat support surface on which an individual with a hypo-mobilized vertebra may lay in a supine position;
c. selecting a back vertebral mobilizer that includes the following:
   i. a main body made of rigid material includes an upward curved lower surface; and
   ii. two upward curved arms formed on said main body separated by a central void area, each said curved arm curves upward from said lower surface of said main body and terminates at a distal end, each said curved arm is configured and sufficiently spaced apart from the other said curved arm so that said distal ends of said curved arms press against opposite transverse processes on said hypo-vertebra vertebra when said individual lays in a supine position over said main body;
d. placing said lower surface on said main body on said flat support surface;
e. laying in a supine position over said main body so that said distal ends of said curved arms press against said transverse processes on said hypo-mobilized vertebra; and
f. rocking back and forth over said main body to repeatedly press against said distal ends of said curved arms against said transverse processes on said hypo-mobilized vertebra.

In compliance with the statute, the invention described has been described as more or less specific to structural features. It should be understood, however, that the invention is not limited to the specific features shown, since the means and construction shown comprises the preferred embodiments for putting the invention into effect. The invention is therefore claimed in its forms or modifications within the legitimate and valid scope of the amended claims, appropriately interpreted the doctrine of equivalents.

I claim:

1. A back vertebral mobilizer, comprising;
a. a main body made of rigid material configured to support the weight of a person's back when lying horizontally over said main body, said main body includes an upward curved lower surface; and,
b. two upward curved arms formed on said main body, formed between said curved arms is a central void area, said curved arms each include a distal end, said curved arms curve upward and the same angle and distance so that said distal ends press against the transverse processes on a user's vertebra when said lower surface of said main body is placed on a flat surface with said curved arms extending upward and towards the user's head and said user lies in a supine position over said main body with the user's spine axially aligned over said main body.

2. The back vertebral mobilizer, as recited of claim 1, wherein said central void area between said curved arms is configured to avoid contact with a spinous process on said vertebra when said distal ends of said curved arms press against said transverse processes on said vertebra.

3. The back vertebral mobilizer, as recited of claim 1, further includes a round tip formed on said distal end on each said curved arm.

4. A back vertebral mobilizer for individual use with a hypo-mobilized vertebra, comprising:
a. a main body with a curved lower surface; and
b. two upward-extending curved arms, wherein said curved arms have the same length and curvature 1 measurements in length, each said curved arm includes lower curved surface and a distal end and sufficiently spaced apart from each other so that said distal end of each said curved arm presses against opposite transverse processes when said curved lower surface is positioned on a flat support surface and said individual lays in a supine position and longitudinally over said main body and said distal end of each said curved arm press against said hypo-mobilized vertebra.

5. The back vertebrae mobilizer of claim 4, further comprising a central void area formed between said curved arms to facilitate alignment with said transverse processes of a hypo-mobile vertebra.

6. The back vertebral mobilizer, as recited in claim 4, further including a round tip formed on said distal end on each said curved arm.

7. The back vertebral mobilizer, as recited in claim 5, further including a round tip formed on said distal end of each said curved arm.

8. A method for an individual to self-treat hypo-mobilized vertebrae, comprising the following steps:
a. identifying a hypo-mobile vertebrae;
b. selecting a flat support surface on which an individual with a hypo-mobilized vertebra may lay in a supine position;
c. selecting a back vertebral mobilizer that includes the following:
i. a main body made of rigid material includes an upward curved lower surface; and
ii two upward curved arms formed on said main body separated by a central space, each said curved arm curves upward from said lower surface of said main body and terminates at a distal end, each said curved arm is configured and sufficiently spaced apart from the other said curved arm so that said distal ends of said curved arms press against opposite transverse processes on said hypo-vertebra vertebra when said individual lays in a supine position over said main body;
d. placing said lower surface on said main body on said flat support surface;
e. laying in a supine position over said main body so that said distal ends of said curved arms press against said transverse processes on said hypo-mobilized vertebra; and
f. rocking back and forth over said main body to repeatedly press against said distal ends of said curved arms against said transverse processes on said hypo-mobilized vertebra.
